(19) United States
(12) Patent Application Publication
(10) Pub. No.: US 2023/0118889 A1
(43) Pub. Date: Apr. 20, 2023

(54) AUTONOMOUS WORK VEHICLE

(71) Applicant: Polaris Industries Inc., Medina, MN (US)

(72) Inventors: Jacob P. Horky, Shoreview, MN (US); Sai Ashish Kanna, Telangana (IN); Curtis D.J. Johnson, Minneapolis, MN (US); Eric L. Ross, Howell, MI (US); James J. Kenney, Huntington Beach, CA (US); Jill Kolesnikov, Minneapolis, MN (US); Micicah J. King, Long Beach, CA (US); Feruby Famadico, Anaheim, CA (US); Alex C. Ramos, Anaheim, CA (US); Justin T. Sticht, Isanti, MN (US); Andrew J. McNiven, Rancho Santa Margarita, CA (US); Dean A. Sowa, Orange, CA (US)

(21) Appl. No.: 17/566,821

(22) Filed: Dec. 31, 2021

Related U.S. Application Data
(60) Provisional application No. 63/256,941, filed on Oct. 18, 2021.

(51) Int. Cl. B60Q 1/50; B60Q 5/00; B60Q 9/00; B60W 60/00

(52) U.S. Cl. CPC B60Q 1/50; B60Q 5/005; B60Q 9/00; B60W 60/0015; B60W 60/00274; B60W 60/0025

(57) ABSTRACT

A vehicle is disclosed. The vehicle may comprise a plurality of ground engaging members, and a frame supported by the plurality of ground engaging members. The frame may include an operator area having a platform sized and shaped to provide a location for a standing operator and at least one upstanding frame member rearward of the operator area. The vehicle may further comprise a steering input operatively coupled to at least one of the plurality of ground engaging members to steer the vehicle; and at least one communication device supported by the at least one upstanding frame member rearward of the operator area, the at least one communication member being positioned higher than the steering input.

### RELATED APPLICATION

This application claims the benefit of U.S. Provisional Application Ser. No. 63/256,941, filed Oct. 18, 2021, the entire disclosure of which is expressly incorporated by reference herein.

### FIELD

The present invention relates to the uses and control of autonomous work vehicles.

### BACKGROUND

The present disclosure pertains to autonomous vehicles and the use thereof in a work setting, including work related features and settings for operating in a work setting, such as a warehouse, airport, or loading dock.

### SUMMARY

In an exemplary embodiment of the present disclosure a vehicle is provided. The vehicle comprising: a plurality of ground engaging members, a frame supported by the plurality of ground engaging members, a steering input operatively coupled to at least one of the plurality of ground engaging members to steer the vehicle, and at least one communication device. The frame including an operator area having a platform sized and shaped to provide a location for a standing operator and at least one upstanding frame member rearward of the operator area. The at least one communication device supported by the at least one upstanding frame member rearward of the operator area and positioned higher than the steering input.

In an example thereof, the at least one communication device includes at least one of an audio communication device and a visual communication device.

In another example thereof, the at least one communication device includes at least one audio communication device and the vehicle further comprises a controller operatively coupled to the at least one audio communication device to produce one or more unique sounds with the at least one audio communication device. In a variation thereof, the one or more unique sounds are based on at least one of a status of the vehicle, a state of the vehicle, a behavior of the vehicle, and an operation of the vehicle. In a further variation thereof, the one or more unique sounds may indicate one or more of a notification prior to a movement of the vehicle, a normal operation of the vehicle when the vehicle is stationary, a normal operation of the vehicle when the vehicle is moving, a deceleration of the vehicle, the vehicle is stationary, the vehicle is turning, the vehicle is stopped at unload zone is the environment, an emergency stop supported by the vehicle is engaged, a soft stop of the vehicle is occurring, the vehicle is unable to determine a location of the vehicle relative to a predetermined map of the environment, the vehicle is disconnected from a communication network, the vehicle is blocked from proceeding on a planned route in the environment, an operator override is active, the vehicle is at a charging zone in the environment ready to charge a powertrain of the vehicle, the vehicle is charging the powertrain of the vehicle, the vehicle is approaching an intersection or an obstruction, the vehicle is entering a narrow corridor, a movement of the vehicle is locked, the vehicle is in remote mode for mapping the environment, and an operator changes a vehicle mode from a manual mode to an autonomous mode.

In a further example thereof, the at least one communication device includes at least one visual communication device and the vehicle further comprises a controller operatively coupled to the at least one visual communication device to produce one or more unique visual cues with the at least one visual communication device. In a variation thereof, the one or more unique visual cues are based on one of a status of the vehicle, a state of the vehicle, a behavior of the vehicle, and an operation of the vehicle. In another variation thereof, the at least one visual communication device includes a display capable of communicating one or more messages, the one or more messages including one or more of human-readable messages and machine-readable messages. In a further variation thereof, the one or more messages relate to at least one of a required operator interaction with the vehicle, an operation of the vehicle, a notification prior to movement of the vehicle, a normal operation of the vehicle when the vehicle is one of stationary and moving, a deceleration of the vehicle, the vehicle is stationary, the vehicle is turning, the vehicle is stopped at an unload zone in an environment, the vehicle is engaged in an emergency stop, the vehicle is engaged in a soft stop, the vehicle is unable to determine a location of the vehicle relative to a predetermined map of the environment, the vehicle is disconnected from a communications network, the vehicle is blocked from proceeding on a planned route in the environment, an operator override is active, the vehicle is at a charging zone in the environment ready to charge a powertrain of the vehicle, the vehicle is charging the powertrain of the vehicle, the vehicle has a low battery charge, the vehicle is approaching an intersection or an obstruction in the environment, the vehicle is entering a narrow corridor in the environment, the vehicle is locked, the vehicle is stationary and waiting for a job, the vehicle is in a remote mode for mapping the environment, and an operator changes a vehicle mode from a manual mode to an autonomous mode.

In still another example thereof, vehicle further comprises a controller including a processor and a memory, the controller being operatively coupled to the at least one communication device; and at least one sensor supported by the plurality of ground engaging members and operatively coupled to the controller. In a variation thereof, the controller is configured to operate the vehicle in an autonomous mode in a constrained environment. In a further variation thereof, the operation in the constrained environment includes one or more of a predetermined path of travel for the vehicle, monitoring stationary obstacles, monitoring moving obstacles, control of longitudinal vehicle stability during speed changes, control of lateral vehicle stability, a trajectory control of the vehicle, and monitoring a grade of the vehicle. In another variation thereof, the vehicle is attached to a number of carts to be towed and wherein operation in the constrained environment includes a vehicle control based on the number of carts attached to the vehicle to be towed. In still a further variation thereof, the controller prevents autonomous operation of the vehicle if the number of carts exceeds a predetermined number of carts based on at least one characteristic of the constrained environment. In yet another variation thereof, the at least one characteristic of the constrained environment includes one of a width of a corridor in the environment, a number of turns the vehicle will have to traverse in the environment, a severity of angled turns the vehicle will have to traverse in the environment. In still yet another variation thereof, the at least one sensor includes one or more radar sensors, optical sensors, light detection and ranging (LiDAR) sensors, ultrasonic sensors, cameras, accelerometers, and inclinometers. In a further still variation thereof, the controller determines an anticipated path of a moving object in the environment and whether the anticipated path intersects a planned trajectory of the vehicle.

In a still further example thereof, the vehicle further comprises at least one emergency stop user input positioned at least at one of forward of the steering input and on the at least one upstanding frame member.

In another exemplary embodiment of the present disclosure, a method of controlling operation of a vehicle through a computer system is provided. The method comprising monitoring with the computer system one or more sensors which monitor one or more vehicle characteristics; determining with the computer system based at least on the one or more monitored vehicle characteristics if the vehicle is in an alert condition; and providing with the computer system an alert regarding the alert condition if the vehicle is determined to be in the alert condition, wherein the one or more monitored vehicle characteristics include at least one of: a pending movement of the vehicle, a movement of the vehicle, a deceleration of the vehicle, the vehicle being stationary, the vehicle turning, the vehicle being positioned in an unload zone in the environment, a vehicle emergency stop, a vehicle soft stop, an inability of the vehicle to determine its location in the environment, the vehicle being disconnected from a network, the vehicle being blocked from proceeding on a planned route, an operator override of the vehicle is active, the vehicle is positioned at a charging zone in the environment, the vehicle is approaching an intersection in the environment, the vehicle is entering a particular location in the environment, the vehicle is locked and is awaiting an operator input, the vehicle is waiting for an assignment, the vehicle is in a remote mode for mapping, and an operator changes the operation mode of the vehicle.

In an example thereof, the alert is at least one of an audio alert, a visual alert, a haptic alert.

### BRIEF DESCRIPTION OF THE DRAWINGS

FIG. 1 is a perspective view of an exemplary vehicle of the present disclosure;

FIG. 2 is a left side perspective view of the vehicle of FIG. 1;

FIG. 3 is a partially transparent perspective view of the vehicle of FIG. 1;

FIG. 4 is a rear view of the vehicle of FIG. 1;

FIG. 5 is a partial side right view of the vehicle of FIG. 1;

FIG. 6 is a partial side left view of the vehicle of FIG. 1;

FIG. 7 is a top view of the vehicle of FIG. 1;

FIG. 8 is a technical specification sheet of one or more carts connectable in a train for use with the vehicle of FIG. 1;

FIG. 9 is a left side partial view of the base of the vehicle of FIG. 1;

FIG. 10 is a partial rear view of the base of the vehicle of FIG. 1;

FIG. 11 illustrates a diagram of an exemplary computing system for implementing aspects of automatic vehicle control;

FIG. 12 is an exemplary processing sequence of the vehicle of FIG. 1;

FIG. 13A displays a schematic of the vehicle of FIG. 1 with a plurality of child carts in an oversteer configuration;

FIG. 13B displays a schematic of the vehicle of FIG. 1 with a plurality of child carts in an understeer configuration;

FIG. 13C displays a schematic of the vehicle of FIG. 1 with a plurality of child carts in an intended vehicle path configuration;

FIG. 14 displays a schematic of the vehicle of FIG. 1 with a plurality of child carts in an intended cornering path;

FIG. 15 displays a schematic of the vehicle of FIG. 1 with a plurality of child carts detecting a potential intersection path with an object;

FIG. 16A displays the vehicle of FIG. 1 autonomously traversing an uphill ramp; and

FIG. 16B displays the vehicle of FIG. 1 autonomously traversing a downhill ramp.

### DETAILED DESCRIPTION OF THE DRAWINGS

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

In some instances throughout this disclosure and in the claims, numeric terminology, such as first, second, third, and fourth, is used in reference to various operative transmission components and other components and features. Such use is not intended to denote an ordering of the components. Rather, numeric terminology is used to assist the reader in identifying the component being referenced and should not be narrowly interpreted as providing a specific order of components.

As discussed herein, a vehicle 2 may include a manually operated vehicle, a semi-autonomous vehicle, or an autonomous vehicle. In some examples, the vehicle 2 may include a tow tractor. In some examples, the vehicle may include a TT-416 tow tractor or C-432A burden carrier available from Polaris, Inc., Medina, Minn.

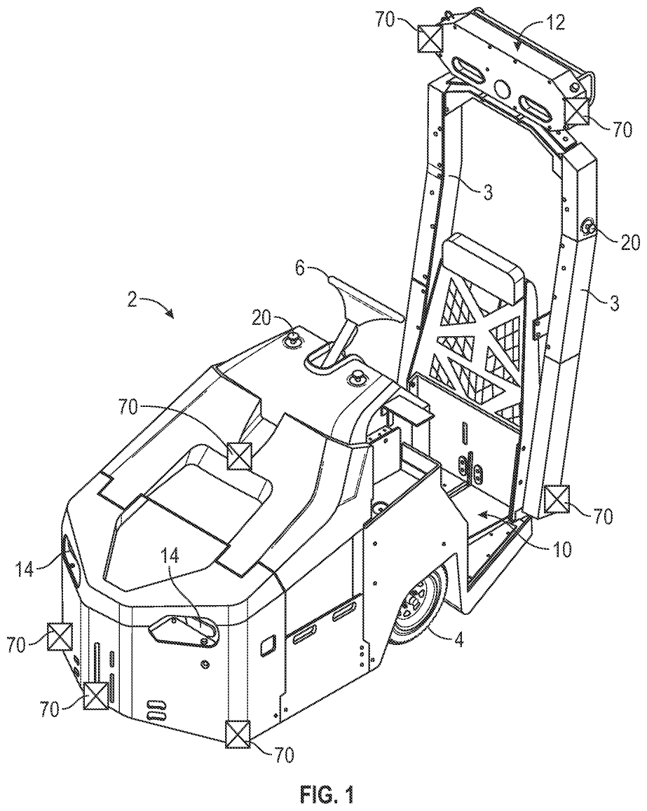

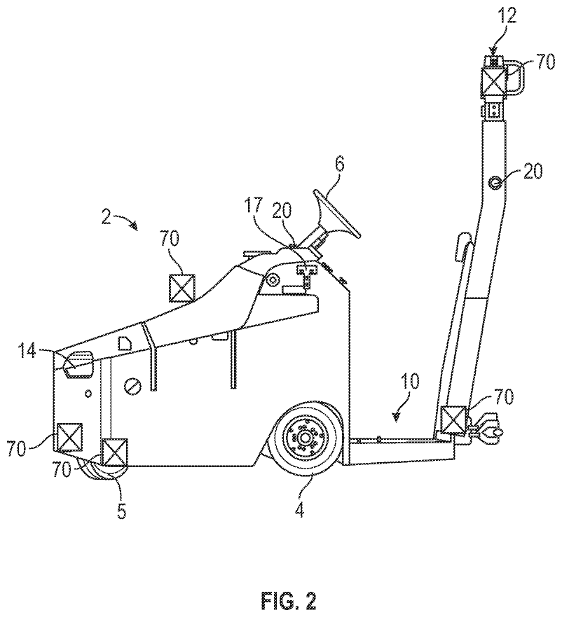

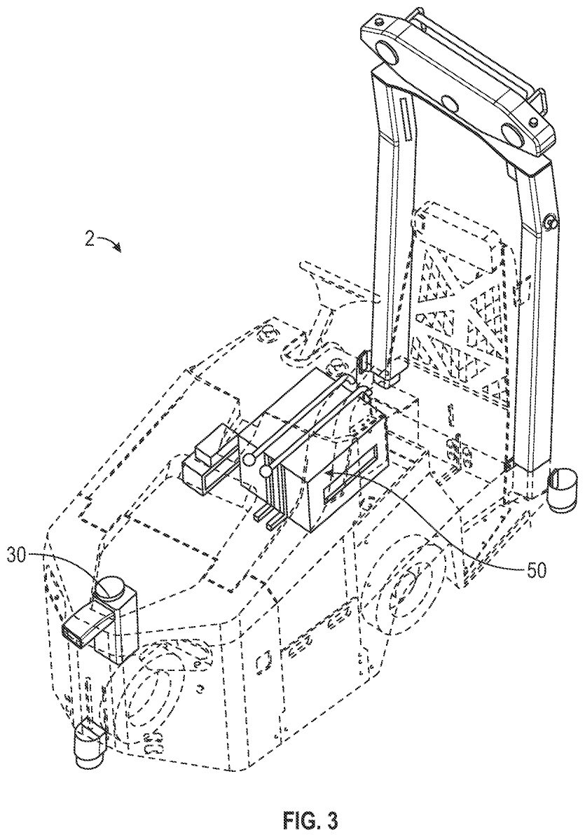

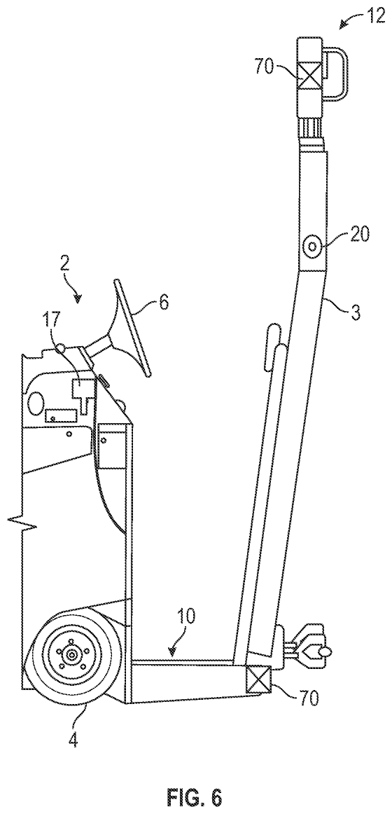

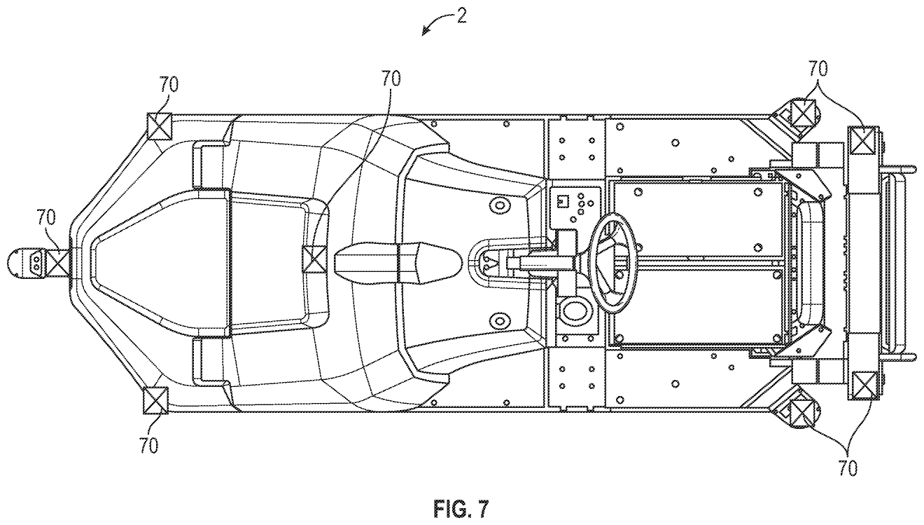

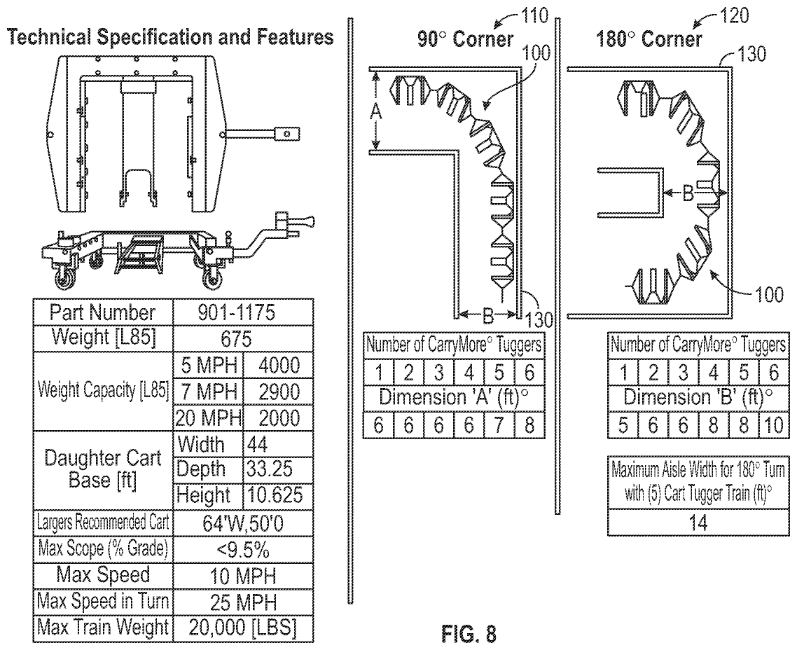

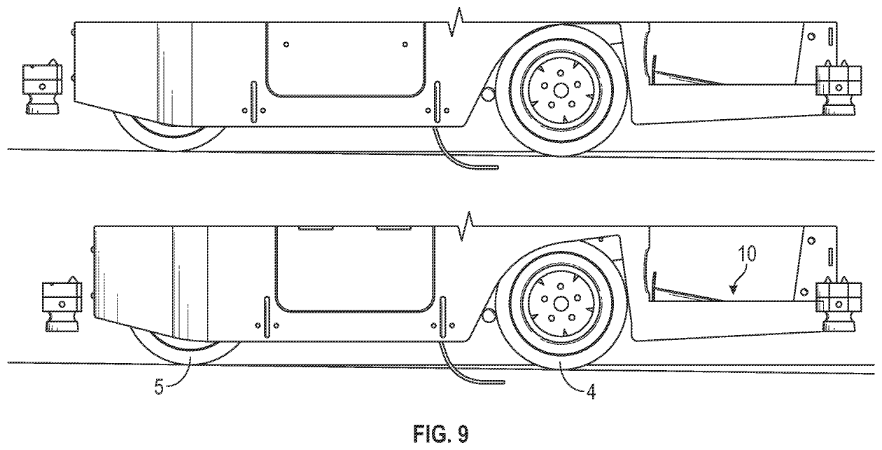

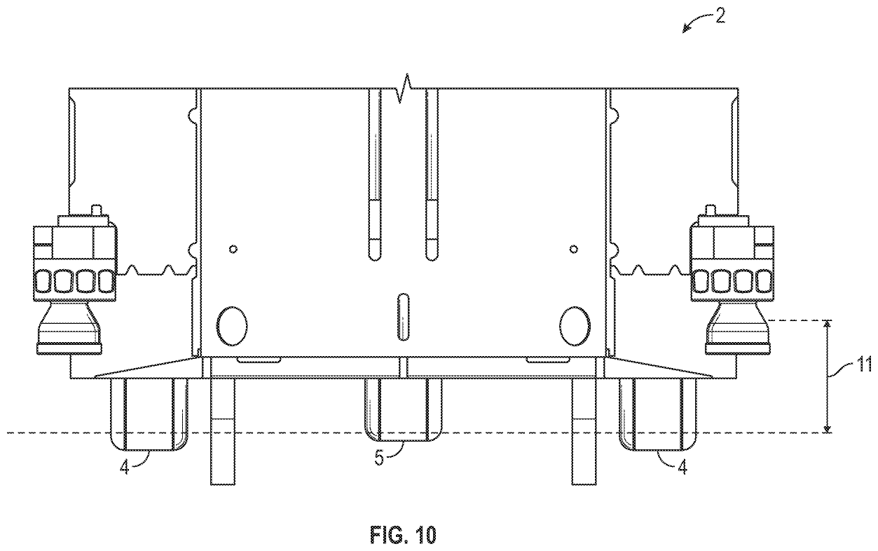

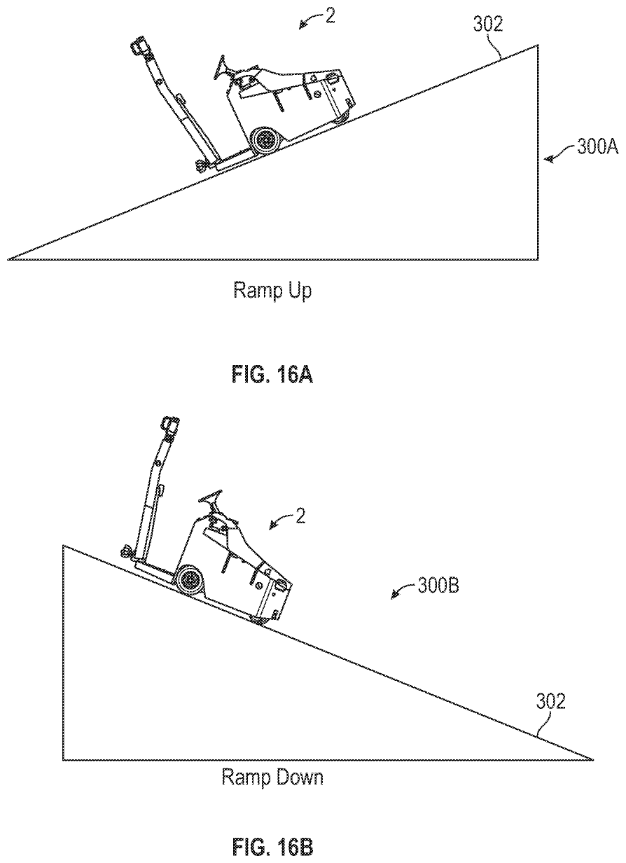

Now referring to FIGS. 1-7, in the present embodiment, vehicle 2 comprises a plurality of rear ground engaging members 4, and at least a single forward ground engaging member 5 (see FIG. 2). Vehicle 2 further comprises a frame including an operator area 10 configured to support an operator (not shown), and illustratively, operator area 10 is located between a steering input 6 and upstanding frame members 3 and has a height 11 (FIG. 10) above the ground 302 (FIG. 16A). Operator area 10 is illustrated as a platform to support the operator in a standing position. Steering input 6 controls at least one of the plurality of ground engaging members 4, 5 through a mechanical actuation or an electrical actuation. In various embodiments, steering input 6 provides an electrical signal to an electronic power steering unit (not shown) which steers at least one of the plurality of ground engaging members 4, 5. Vehicle 2 is further propelled by a powertrain 50 (see FIG. 3), which may comprise a plurality of batteries coupled to at least one electric motor. At least one controller may be coupled to powertrain 50, which may be further coupled to drive ground engaging members 4, 5. Vehicle 2 may further comprise a pair of headlights 14 located at a front of vehicle 2. Further, vehicle 2 may further have a display pod 12 coupled to an upper extent of upstanding frame members 3. Illustratively, vehicle 2 may further comprise a plurality of emergency stop buttons 20 coupled to area accessible by an operator. Emergency stop buttons 20 may engage brakes, reduce throttle control, or otherwise bring vehicle 2 to a stop. In the present embodiment, emergency stop buttons 20 may be located on upstanding frame members 3, or adjacent to the steering input 6. In various embodiments, steering input 6 is positioned adjacent the operator area 10.

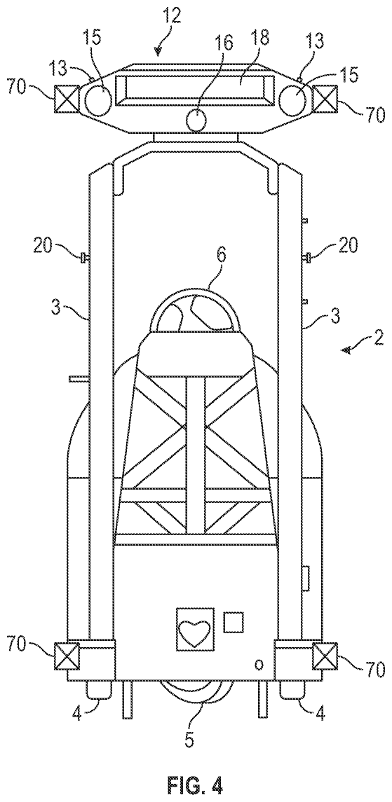

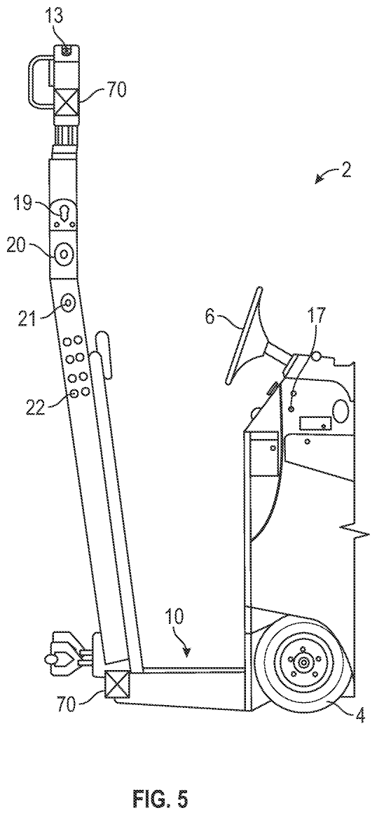

Still referring to FIGS. 1-7, display pod 12 may comprise a variety of components configured to alert the operator and surrounding areas of the presence of vehicle 2. Illustratively, such as in FIG. 4, display pod 12 comprises a pair of strobe lights 13, a bus display 18, a speaker 16, and a pair of lights configured to light up during braking, turning, or during other operations of vehicle 2. Now referring to FIG. 5, upstanding frame members 3 may further comprise a plurality of inching buttons 19, a release button 20, and a plurality of lights configured to display information about child carts connected to vehicle 2. Vehicle 2 may further comprise a plurality of marker lights 17 configured to indicate the status of vehicle 2. Illustratively, marker lights 17 are on either side of vehicle 2. Further, vehicle 2 comprises a forward speaker 30 (see FIG. 3) configured to point in a forward direction. In various embodiments, forward speaker 30 is multi-directional.

Audible and Visual Communications

One or more communication devices are supported by upstanding frame member 3 at a position above steering input 6. Exemplary communication devices include audio communication devices, such as speakers and other suitable audio communication devices, and visual communication devices, such as lights, displays, and other suitable visual communication devices. During operation of the vehicle 2, there may be a need to audibly communicate features associated with an operation of the vehicle 2 to one or more operators and/or bystanders. In some examples, the vehicle 2 may be configured to produce one or more unique sounds using speaker 16 (see FIG. 4) selected based on one or more of the status of the vehicle 2, the state of the vehicle 2, behaviors of the vehicle 2, and/or other features associated with an operation of the vehicle 2. In some examples, the sounds may be based on a preselected sound palate. In some examples, the one or more unique sounds may indicate one or more of a notification prior to movement, normal operation when vehicle 2 is stationary or moving, vehicle 2 is decelerating, vehicle 2 is stationary, vehicle 2 is turning, vehicle 2 is stopped at unload zone, an emergency stop is engaged, a soft stop is occurring, vehicle 2 is currently unable to determine a location of the vehicle 2 relative to a predetermined map, vehicle 2 is disconnected from a communications signal (e.g., Wi-Fi, Bluetooth, cellular, electromagnetic-based signals, or light-based signals), vehicle 2 is blocked from proceeding on its planned route 104, operator override is active when vehicle 2 is stationary or moving, vehicle 2 is at a charging zone ready to charge, vehicle 2 is charging, vehicle 2 is approaching an intersection or an obstruction 200, vehicle 2 is entering a narrow corridor 130, movement of vehicle 2 is locked as it waits for further user input, vehicle 2 is stationary and waiting for next job, vehicle 2 is in remote mode for mapping, an operator changes a vehicle mode from manual to autonomous, or other operations of the vehicle 2.

During operation of vehicle 2, there may be a need to visually communicate features associated with an operation of the vehicle 2 and/or interaction messages to one or more operators and/or bystanders. In some examples, visual communications may be clearer and/or better understood at greater distances from the vehicle, compared to other means of communication. In some examples, vehicle 2 comprises bus display 18 (e.g., an integrated dot matrix display) on a display pod 12 of vehicle 2. The bus display 18 may be configured to display human-readable and/or machine-readable messages. The bus display 18 may be large enough and bright enough to be readable from a selected distance from the vehicle 2. For example, a selected distance may be greater than 50 feet, greater than 100 feet or greater than 200 feet. The bus display 18 may face any suitable direction, including the front of vehicle 2, the rear of vehicle 2, either side of vehicle 2, the top of vehicle 2, the bottom of vehicle 2, or a combination thereof. In various embodiments, bus display 18 may be a dot matrix display, an LED display, an LCD display, a CRT display, or other type of display capable of displaying human-readable and/or machine-readable messages.

In some examples, the bus display 18 may be configured to display characters, such as symbols, text, scrolling symbols and/or text, calibratable messages, messages based on facility protocol and/or workflow, messages indicated a required operator interaction with vehicle 2, messages indicative of an operation of vehicle 2, or other messages. In some examples, messages may change based on an operation of vehicle 2. For example, on bus display 12, messages may flash or be indicated in a selected color to indicate a required operator interaction with vehicle 2 or communicate a selected urgency of the message or indicate communication meant for a specific person or group.

Predetermined messages may be displayed for any suitable scenario, e.g., selected operations of vehicle 2 or interactions of vehicle 2 with a surrounding environment. Example scenarios where one or more predetermined messages may be displayed include, but are not limited to, vehicle notification prior to movement, normal operation when vehicle 2 is stationary and/or moving, vehicle 2 is decelerating, vehicle 2 is stationary, vehicle 2 is turning, vehicle 2 is stopped at unload zone, vehicle 2 is engaged in an emergency stop, vehicle 2 is engaged in a soft stop, vehicle 2 is currently unable to determine a location of vehicle 2 relative to a predetermined map, vehicle 2 is disconnected from a communications signal (e.g., Wi-Fi, Bluetooth, cellular, or other radio signal), vehicle 2 is blocked from proceeding on its planned route 104, operator override is active when vehicle 2 is stationary or moving, vehicle 2 is at a charging zone ready to charge, vehicle 2 is charging, vehicle 2 is low on battery, vehicle 2 is approaching an intersection or an obstruction 200, vehicle is entering a narrow corridor 130, the movement of vehicle 2 is locked as it waits for further user input, vehicle 2 is stationary and waiting for next job, vehicle 2 is in remote mode for mapping, operator changes mode from manual to autonomous, or other operations of the vehicle 2.

Vehicle 2 may include additional audio or visual communication devices and/or safety devices. In some examples, the additional audio or visual communication devices and/or safety devices may be integrated with display pod 12 of vehicle 2. The additional audio or visual communication devices may include, for example, one or more of strobe light 13, brake light/turn signal/brake light 15, speaker 16, and may further include a marker light, a blue light, a forward facing light, a head light, a reverse light, a child cart light, a reverse beeper, a speaker 16, or the like. Illustratively, on upper frame members 3, the one or more safety devices may include, for example, a release button 21, an inching button 19, an emergency stop switch 20, a warning device, an emergency device, a non-emergency device, or other devices configured to indicate or alter an operation of the vehicle. In this way, vehicle 2 may be configured to enable selected safety features and/or selected communications with operators and/or bystanders.

Safety devices, in some examples, may be configured to alert personnel and/or protect personnel from contact with the vehicle. Example situations of safety device activation may include, for example, initiation of vehicle movement or remote reactivation from sleep or inactive condition, reversing of vehicle, traversing of vehicle, or direction pivoting, loss of path reference or deviation from intended path of travel, loss of speed control, other control system malfunctions that require intervention by an operator, low battery condition when automatic routing to battery charging is not provided, or other operations of the vehicle. In some examples, selected situations of safety device activation may produce a unique combination of audible or visual indicators.

Autonomous Tugging Carts

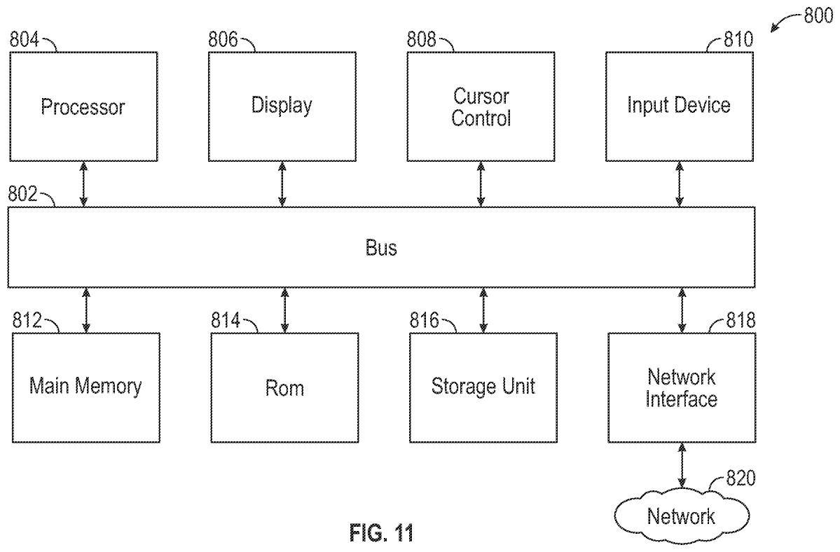

Vehicle 2 may be configured to operate autonomously in constrained environments. For example, vehicle 2 may include one or more sensors 70 and main memory 812 (FIG. 11) operatively coupled to processor 800 configured to autonomously determine an operation of vehicle 2 in the constrained environments. The constrained environments may include, for example, predetermined paths of travel 104, stationary or moving obstacles 200, or the like. The one or more sensors 70 may include, for example, one or more of radar sensors, optical sensors, light detection and ranging (LiDAR) sensors, ultrasonic sensors, cameras, or the like.

The memory 812, e.g., a computer-readable storage medium, may store instructions that, when executed by the processor 800, enable autonomous operation of vehicle 2. In some examples, the memory 812 may store data indicative of field-sets. The field-sets may include, for example, a map or other representation of an area in which vehicle 2 may travel, paths of travel, or the like. Additionally, or alternatively, field-sets and/or parameters for autonomous operation of vehicle 2 may be based at least in part on a longitudinal control of vehicle 2, (e.g., stability of vehicle 2 during acceleration and/or deceleration), based upon a lateral control of vehicle 2, (e.g., stability of the vehicle during turning), and/or trajectory control, (e.g., one or more parameters configured to produce and/or limit a selected lateral acceleration for a predetermined path to avoid corner collision of the subject vehicle with other traffic objects).

In the present embodiment, vehicle 2 is configured to be coupled to and tow a plurality of carts 60. In various embodiments, the field-sets may be selected based at least in part on the number of carts 60 being pulled by vehicle 2, such as no (zero) carts, one cart, or additional carts, such as five carts. In this way, selected field-sets may be configured to represent a width of a path of travel of the vehicle and, optionally, a selected number of carts. In some examples, a permissible number of carts may be constrained by, for example, selected paths of travel or other features of the constrained environment such as the width of corridor 130, the number of turns vehicle 2 may have to traverse, and the severity of angled turns vehicle 2 will have to traverse. For example, the vehicle may be configured to prevent autonomous operation within a selected constrained environment if a predetermined number of carts is exceeded.

In various examples, vehicle 2 may be a quad-steer cart that may tow load bearing child carts 60. In various embodiments, quad-steer carts with load bearing child carts may more closely follow the track of the cart in front of them, for selected load conditions (e.g., even when heavily loaded), and during selected deceleration rates, compared to other types of carts. By using quad-steer carts with load bearing child carts, vehicle 2 may use more constrained field-sets compared to other vehicle systems to safely operate autonomously in constrained environments.

Positioning of Sensors

In some examples, a positioning of one or more sensors 70 may be selected to provide a selected vehicle coverage. In some examples, the selected vehicle coverage may include an entire surround of vehicle 2 of a portion thereof. In some examples, the one or more sensors 70 may be configured to provide information about paths of travel or obstructions 200 (e.g., objects or personnel) in detection range covering all blind spots of vehicle 2.

In one example, the one or more sensors 70 include three LiDAR sensors, such as two-dimensional or three-dimensional LiDAR sensors available from SICK, Inc., Minneapolis, Minn. A first LiDAR sensor 70 may be positioned in a front center of the vehicle. A second and a third LiDAR sensors may be positioned, respectively, in a rear-left and a rear-right corner of the vehicle. The positioning of the three LiDAR sensors 70 is configured to detect obstructions around the vehicle covering 360 degree with no or minimal blind zones.

In one example, the one or more sensors 70 may go through a test piece detection process in order to be properly calibrated for the system and specifically calibrated to vehicle 2. In one example, a plurality of test pieces may be placed in the path 104 of the vehicle (including onboard payload, equipment, towed trailer and/or trailer payload) while vehicle 2 is traveling at a variety of speeds. In an exemplary embodiment, those speeds are 0%, 50%, and 100% of full vehicle speed. In the calibration process, a plurality of test pieces will be used for the sensors 70 to detect and calibrate to, and the test pieces may comprise a plurality of characteristics depending upon what type of sensors 70 are being calibrated. In the case of an optical sensor being used as detection devices, the test pieces may be a cylindrical test piece or a flat test piece with a set external surface reflectance and optical density. In an exemplary embodiment, for testing optical sensors, the external surface reflectance of the cylindrical test piece is 6% or less and the optical density is 1.22 or less, and the flat test piece may have a highly reflective, polished metal surface of at least 88% reflectivity. In yet another exemplary embodiment, for testing ultrasonic sensors, the flat test pieces may have a highly reflective surface, also.

Still referring to the calibration of various sensors 70, the following test pieces also apply: (a) a test piece with a diameter of 200 mm and a length of 600 mm lying on and at 0° and 45° to the path of the vehicle, at a range equivalent to the vehicle safe stopping distance and positioned at the left-most, right-most and center of the vehicle path 104, (b) a test piece with a diameter of 70 mm and a height of 400 mm set vertically at a range equivalent to the vehicle safe stopping distance and positioned at the left-most, right-most and center of the vehicle path 104, (c) a test piece with a flat surface measuring 500 mm square set vertically, and at test angles of 0° and 45° perpendicular to the path of the vehicle, with closest point of the test piece at a range equivalent to the vehicle safe stopping distance and positioned at the left-most, right-most and center of the vehicle path 104.

In some examples, sensors 70 may be positioned on vehicle 2 or otherwise shrouded to protect sensors 70 from impact with obstructions 200.

Vehicle Stability

In some examples, a stability of vehicle 2 (including any carts 60) may be maintained to avoid overturning during acceleration, deceleration, and/or turning modes under selected load capacities and/or selected grades of a surface 302. The selected load capacities may include loads ranging from no (zero) load to a full load (e.g., based on vehicle specifications). Grades of surface 302 may include a slope (e.g., angle) of a surface and/or changes in a relative elevation of a surface (e.g., bumps). Surface composition may also be a factor (e.g. loose gravel, cement, dirt, acrylic flooring, etc.) Factors affecting stability of vehicle 2 may include, for example, weight, weight distribution, wheelbase, wheel tread, method of suspension, vehicle speed, vehicle turning radius, tire and/or mast deflection under load, or other features of vehicle operation.

In some examples, a stability of vehicle 2 may be maintained by controlling jerk limits both laterally and longitudinally such that the vehicle can follow the assigned route smoothly, e.g., with minimized or no jerks. In some examples, vehicle 2 may be configured to determine a planned trajectory to satisfy a selected transit time, speed, or route for vehicle 2. The planned trajectory may be constrained by one or more lateral acceleration limits to avoid unnecessary overturning which may lead to instability of vehicle 2. In some examples, the planned trajectory may be based on, at least in part, load conditions, surface grades, longitudinal control constraints, lateral control constraints, or other operations of vehicle 2.

Ramps

Referring now to FIGS. 16A-16B, vehicle 2 may be configured to operate autonomously in constrained environments including ramps (e.g., 300A or 300B) or other inclined surfaces. For example, vehicle 2 may be configured to determine or detect one or more of an inclination of surface 300A, a roll back or forward (e.g., due to gravity), a speed adjustment to compensate for an incline 300A, a stop-and-go or braking adjustment, or other operations of vehicle 2. In some examples, operations of vehicle 2 on inclines 300A may be predetermined for any applicable load capacities over a selected range of grade surfaces 302.

For example, during an uphill climb, vehicle 2 may be configured to determine an additional propulsion torque to maintain a selected speed and/or to avoid roll-back in a stop-and-go operation on an incline 300A. As another example, during a downhill descent, vehicle 2 may be configured to determine a brake force to maintain a selected speed and/or to avoid possible roll-forward in a stop-and-go operation on a decline 300B. As another example, a negative torque may be applied to any or all electric motors of the powertrain 50 of vehicle 2 to maintain a selected speed and/or to avoid possible roll-forward in a stop-and-go operation on a decline 300B.

In some examples, the above determinations may be based on, at least in part, one or more of a speed-based controller, aerodynamic forces, rolling resistance, gravity, or other factors affecting an operation of vehicle 2. For example, a speed controller of vehicle 2 may be configured to control an error between a selected commanded speed and a detected actual speed of vehicle 2. In some examples, a gain scheduling of the speed controller may be based on field testing for selected grades of surface 302. As another example, vehicle 2 may be configured to compensate an acceleration command and/or a deceleration command based on, at least in part, rolling resistance of vehicle 2, gravity, and/or aerodynamic forces acting on vehicle 2.

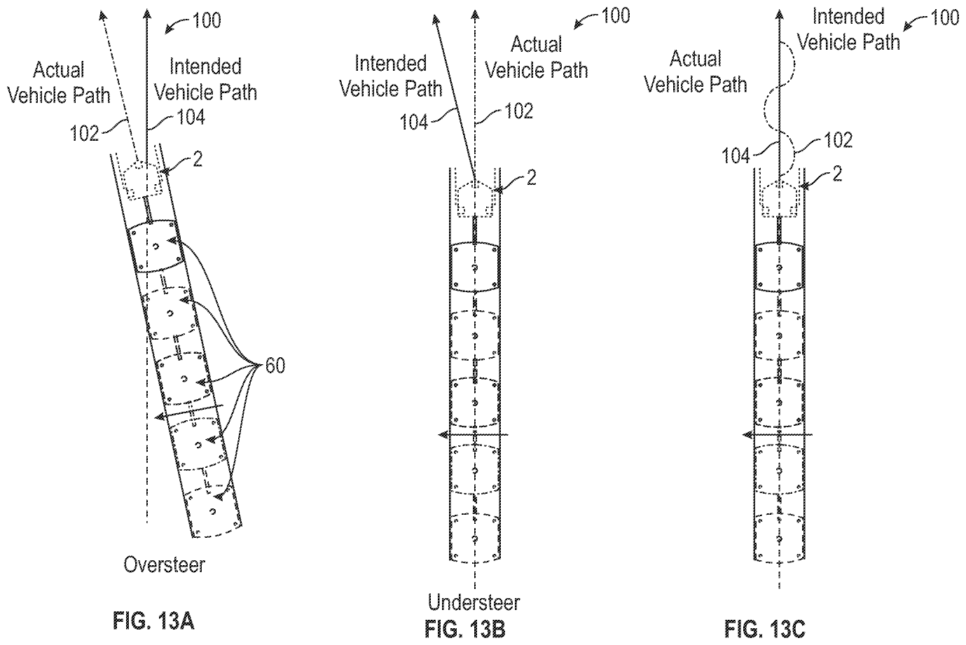

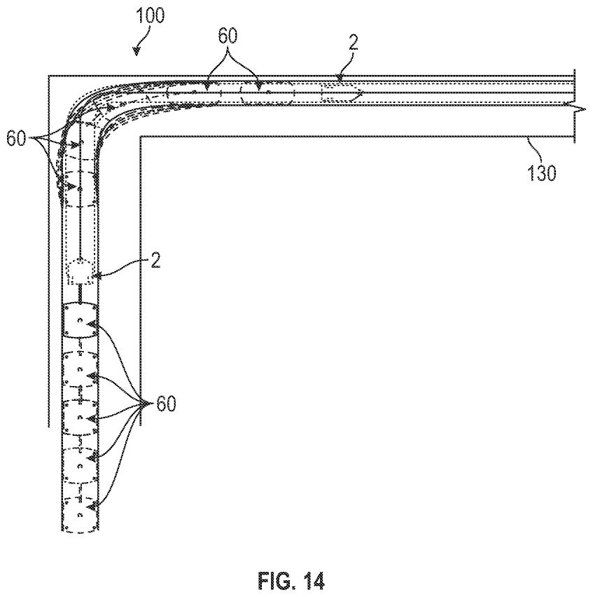

Referring now to FIGS. 13A-14, vehicle 2 is shown comprising a plurality of child carts 60. Illustratively, child carts 60 are configured to follow the actual vehicle path 102 of vehicle 2. The actual vehicle path 102 may vary from the intended vehicle path 104 in order to remain stable and/or avoid an object 200 in its path. Further, FIGS. 13A-13C show the result of an oversteer condition (FIG. 13A), and understeer condition (FIG. 13B) and what an actual path might look like (FIG. 13C). Illustratively, when vehicle 2 oversteers, the path of child carts 60 is widened and exaggerated, and when vehicle 2 understeers, the path of child carts remains generally consistent and does not effectively steer into the intended vehicle path 104. As such, vehicle 2 may follow an actual vehicle path 102 that curves or sways back and forth in order to oversteer and understeer, and have an average steering path that follows the intended vehicle path 104.

Referring now to FIG. 14, a traversal path of vehicle 2 and child carts 60 are shown. Illustratively, vehicle 2 is driven so that as vehicle 2 turns through its intended path 104, it may remain within corridor 130 and not run into any obstruction or wall of corridor 130.

Detection of Moving Object and Stationary Object

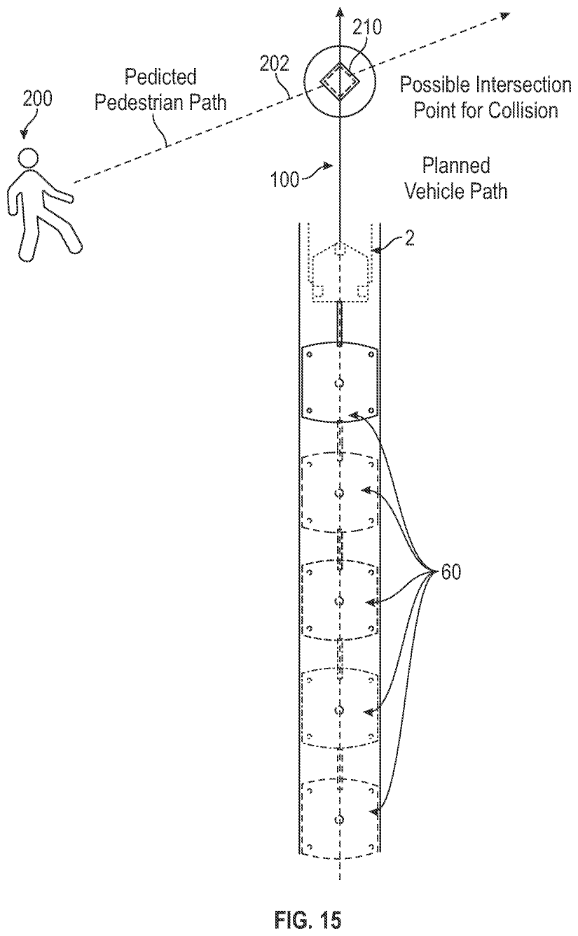

Referring now to FIG. 15, vehicle 2 may be configured to determine whether a detected object 200 is moving or stationary. Examples of moving objects 200 may include, but are not limited to, moving personnel, falling machine parts or material, decoupled machine parts, runaway vehicles, overturned vehicles, or other uncontrolled or unexpected movement of machinery, materials, or personnel. In some examples, vehicle 2 may be configured to determine an anticipated path of travel 202 of a moving object and determining whether the anticipated path 202 may intersect with a planned trajectory 100 of vehicle 2. If yes, vehicle 2 may initiate an operation to avoid the moving object 200. For example, vehicle 2 may initiate a turn into a free-drive corridor 130 that is clear of obstructions 200 (e.g., escape path maneuver) or a braking procedure. If no, vehicle 2 may maintain course or initiate an operation to reduce a possibility of conflict with the moving object 200. For example, vehicle 2 may operate at reduced speeds when in a selected proximity to personnel. In some examples, in response to detection of a moving object 200, vehicle 2 may be configured to perform, at an increased sampling rate, the determination of the anticipated path 100 of travel of the moving object 200 and/or the determination of whether the anticipated path 202 may intersect with the planned trajectory 100 of the vehicle. Vehicle 2 may also be configured to alert a user or remote user of the unplanned or unpredicted movements through use of a wireless communication protocol. That is, if vehicle 2 registers an unpredicted movement (e.g. a falling part or assembly from a warehouse rack), vehicle 2 would send an alert to a user or remote user of the encounter.

FIG. 11 illustrates a diagram of a computing system 800 for implementing aspects of automatic vehicle control according to aspects described herein. This diagram is merely an example, which should not unduly limit the scope of the claims. One of ordinary skill in the art would recognize many variations, alternatives, and modifications.

The computing system 800 includes a bus 802 or other communication mechanism for communicating information between, a processor 804, a display 806, a cursor control component 808, an input device 810, a main memory 812, a read only memory (ROM) 814, a storage unit 816, and/or a network interface 818. In various embodiments, the input device 810 includes the plurality of sensors 70. In some examples, the bus 802 is coupled to the processor 804, the display 806, the cursor control component 808, the input device 810, the main memory 812, the read only memory (ROM) 814, the storage unit 816, and/or the network interface 818. And, in certain examples, the network interface 818 is coupled to a network 820 such as wi-fi or other wireless networks. In various embodiment, computing system 800 further comprises an accelerometer (not shown) and/or an inertial measurement unit (IMU) configured to detect a vehicle angle, other inclination values, G-force values, directional headings, or other values.

In some examples, the processor 804 includes one or more general purpose microprocessors. In some examples, the main memory 812 (e.g., random access memory (RAM), cache and/or other dynamic storage devices) is configured to store information and instructions to be executed by the processor 804. In certain examples, the main memory 812 is configured to store temporary variables or other intermediate information during execution of instructions to be executed by processor 804. For example, the instructions, when stored in the storage unit 916 accessible to processor 804, render the computing system 800 into a special-purpose machine that is customized to perform the operations specified herein. In some examples, the ROM 814 is configured to store static information and instructions for the processor 804. In certain examples, the storage unit 816 (e.g., a magnetic disk, optical disk, or flash drive) is configured to store information and instructions.

Thus, computing system 800, also referred to as a controller, may include at least some form of computer readable media. The computer readable media may be any available media that can be accessed by processor 804 or other devices. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may not include communication media.

In some embodiments, the display 806 (e.g., a cathode ray tube (CRT), an LCD display, or a touch screen) is configured to display information to a user of the computing system 800. In some examples, the input device 810 (e.g., alphanumeric and other keys) is configured to communicate information and commands to the processor 804. For example, the cursor control 808 (e.g., a mouse, a trackball, or cursor direction keys) is configured to communicate additional information and commands (e.g., to control cursor movements on the display 806) to the processor 804.

In embodiments, the exemplary embodiments disclosed herein may be operated in either a manual mode with a driver supported by the vehicle and controlling operation of the vehicle through one or more operator controls and an autonomous or semi-autonomous mode.

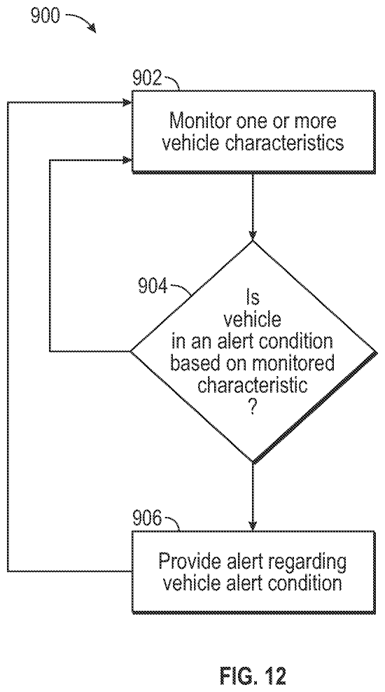

Referring to FIG. 12, an exemplary processing sequence 900 is shown which is executed by the computer system 800 of the exemplary vehicle embodiments disclosed herein. The computer system 800 through one or more sensors monitors one or more vehicle characteristics, as represented by block 902. Computer system 800 based on the monitored characteristic, and optionally one or more additional characteristics, determines if the vehicle is in an alert condition, as represented by block 904. If the vehicle is not in an alert condition, computer system 800 returns to monitoring the one or more vehicle characteristics. If the vehicle is in an alert condition, computer system 800 provides an alert regarding the vehicle alert condition, as represented by block 906, and returns to monitoring the one or more vehicle characteristics.

Exemplary monitored vehicle characteristics which alone or in combination with other characteristics that may indicate a vehicle alert condition include a pending movement of the vehicle, the vehicle moving, the vehicle decelerating, the vehicle being stationary, the vehicle turning, the vehicle being positioned in an unload zone in an environment and stationary, a vehicle emergency stop, a vehicle soft stop, an inability of the vehicle to determine its location (such as in relation to a loaded map in its memory), the vehicle is disconnected from the network, the vehicle is blocked from proceeding on its planned route, an operator override is active, the vehicle is positioned at a charging zone in an environment, the vehicle is approaching an intersection in an environment, the vehicle is entering a particular location in an environment (such as a narrow corridor), the vehicle is locked and is awaiting user input, the vehicle is waiting for an assignment, the vehicle is in a remote mode for mapping, and an operator changes the operation mode of the vehicle (such as from manual to autonomous). Exemplary alerts provided by the vehicle in response to a vehicle alert condition include audio alerts, visual alerts, haptic alerts, or combinations thereof.

### EXAMPLES

Example 1: A vehicle is provided. The vehicle comprising: a plurality of ground engaging members, a frame supported by the plurality of ground engaging members, a steering input operatively coupled to at least one of the plurality of ground engaging members to steer the vehicle, and at least one communication device. The frame including an operator area having a platform sized and shaped to provide a location for a standing operator and at least one upstanding frame member rearward of the operator area. The at least one communication device supported by the at least one upstanding frame member rearward of the operator area and positioned higher than the steering input.

Example 2: The vehicle of Example 1, wherein the at least one communication device includes at least one of an audio communication device and a visual communication device.

Example 3: The vehicle of Example 1, wherein the at least one communication device includes at least one audio communication device and the vehicle further comprises a controller operatively coupled to the at least one audio communication device to produce one or more unique sounds with the at least one audio communication device.

Example 4: The vehicle of Example 3, wherein the one or more unique sounds are based on one of a status of the vehicle, a state of the vehicle, a behavior of the vehicle, and an operation of the vehicle.

Example 5: The vehicle of Example 3, wherein the one or more unique sounds may indicate one or more of a notification prior to a movement of the vehicle, a normal operation of the vehicle when the vehicle is stationary, a normal operation of the vehicle when the vehicle is moving, a deceleration of the vehicle, the vehicle is stationary, the vehicle is turning, the vehicle is stopped at unload zone is the environment, an emergency stop supported by the vehicle is engaged, a soft stop of the vehicle is occurring, the vehicle is unable to determine a location of the vehicle relative to a predetermined map of the environment, the vehicle is disconnected from a communication network, the vehicle is blocked from proceeding on a planned route in the environment, an operator override is active, the vehicle is at a charging zone in the environment ready to charge a powertrain of the vehicle, the vehicle is charging the powertrain of the vehicle, the vehicle is approaching an intersection or an obstruction, the vehicle is entering a narrow corridor, a movement of the vehicle is locked, the vehicle is in remote mode for mapping the environment, and an operator changes a vehicle mode from a manual mode to an autonomous mode.

Example 6: The vehicle of Example 1, wherein the at least one communication device includes at least one visual communication device and the vehicle further comprises a controller operatively coupled to the at least one visual communication device to produce one or more unique visual cues with the at least one visual communication device.

Example 7: The vehicle of Example 6, wherein the one or more unique visual cues are based on at least one of a status of the vehicle, a state of the vehicle, a behavior of the vehicle, and an operation of the vehicle.

Example 8: The vehicle of Example 6, wherein the at least one visual communication device includes a display capable of communicating one or more messages, the one or more messages including one or more of human-readable messages and machine-readable messages.

Example 9: The vehicle of Example 8, wherein the one or more messages relate to at least one of a required operator interaction with the vehicle, an operation of the vehicle, a notification prior to movement of the vehicle, a normal operation of the vehicle when the vehicle is one of stationary and moving, a deceleration of the vehicle, the vehicle is stationary, the vehicle is turning, the vehicle is stopped at an unload zone in an environment, the vehicle is engaged in an emergency stop, the vehicle is engaged in a soft stop, the vehicle is unable to determine a location of the vehicle relative to a predetermined map of the environment, the vehicle is disconnected from a communications network, the vehicle is blocked from proceeding on a planned route in the environment, an operator override is active, the vehicle is at a charging zone in the environment ready to charge a powertrain of the vehicle, the vehicle is charging the powertrain of the vehicle, the vehicle has a low battery charge, the vehicle is approaching an intersection or an obstruction in the environment, the vehicle is entering a narrow corridor in the environment, the vehicle is locked, the vehicle is stationary and waiting for a job, the vehicle is in a remote mode for mapping the environment, and an operator changes a vehicle mode from a manual mode to an autonomous mode.

Example 10: The vehicle of Example 1, further comprising: a controller including a processor and a memory, the controller being operatively coupled to the at least one communication device; and at least one sensor supported by the plurality of ground engaging members and operatively coupled to the controller.

Example 11: The vehicle of Example 10, wherein the controller is configured to operate the vehicle in an autonomous mode in a constrained environment.

Example 12: The vehicle of Example 11, wherein operation in the constrained environment includes one or more of a predetermined path of travel for the vehicle, monitoring stationary obstacles, monitoring moving obstacles, control of longitudinal vehicle stability during speed changes, control of lateral vehicle stability, a trajectory control of the vehicle, and monitoring a grade of the vehicle.

Example 13: The vehicle of Example 11, wherein the vehicle is attached to a number of carts to be towed and wherein operation in the constrained environment includes a vehicle control based on the number of carts attached to the vehicle to be towed.

Example 14: The vehicle of Example 13, wherein the controller prevents autonomous operation of the vehicle if the number of carts exceeds a predetermined number of carts based on at least one characteristic of the constrained environment.

Example 15: The vehicle of Example 14, wherein the at least one characteristic of the constrained environment includes one of a width of a corridor in the environment, a number of turns the vehicle will have to traverse in the environment, a severity of angled turns the vehicle will have to traverse in the environment.

Example 16: The vehicle of Example 10, wherein the at least one sensor includes one or more radar sensors, optical sensors, light detection and ranging (LiDAR) sensors, ultrasonic sensors, cameras, accelerometers, and inclinometers.

Example 17: The vehicle of Example 10, wherein the controller determines an anticipated path of a moving object in the environment and whether the anticipated path intersects a planned trajectory of the vehicle.

Example 18: The vehicle of Example 1, further comprising at least one emergency stop user input positioned at least at one of forward of the steering input and on the at least one upstanding frame member.

Example 19: A method of controlling operation of a vehicle through a computer system is provided. The method comprising monitoring with the computer system one or more sensors which monitor one or more vehicle characteristics; determining with the computer system based at least on the one or more monitored vehicle characteristics if the vehicle is in an alert condition; and providing with the computer system an alert regarding the alert condition if the vehicle is determined to be in the alert condition, wherein the one or more monitored vehicle characteristics include at least one of: a pending movement of the vehicle, a movement of the vehicle, a deceleration of the vehicle, the vehicle being stationary, the vehicle turning, the vehicle being positioned in an unload zone in the environment, a vehicle emergency stop, a vehicle soft stop, an inability of the vehicle to determine its location in the environment, the vehicle being disconnected from a network, the vehicle being blocked from proceeding on a planned route, an operator override of the vehicle is active, the vehicle is positioned at a charging zone in the environment, the vehicle is approaching an intersection in the environment, the vehicle is entering a particular location in the environment, the vehicle is locked and is awaiting an operator input, the vehicle is waiting for an assignment, the vehicle is in a remote mode for mapping, and an operator changes the operation mode of the vehicle.

Example 20: The method of Example 19, wherein the alert is at least one of an audio alert, a visual alert, a haptic alert.

Example 21: The method of Example 19, wherein the vehicle comprises the vehicle of any one of claims 1 through 18.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A vehicle, comprising:
a plurality of ground engaging members,
a frame supported by the plurality of ground engaging members, the frame including
an operator area having a platform sized and shaped to provide a location for a standing operator and
at least one upstanding frame member rearward of the operator area;
a steering input operatively coupled to at least one of the plurality of ground engaging members to steer the vehicle; and
at least one communication device supported by the at least one upstanding frame member rearward of the operator area, the at least one communication member being positioned higher than the steering input.

2. The vehicle of claim 1, wherein the at least one communication device includes at least one of an audio communication device and a visual communication device.

3. The vehicle of claim 1, wherein the at least one communication device includes an at least one audio communication device and the vehicle further comprises a controller operatively coupled to the at least one audio communication device to produce one or more unique sounds with the at least one audio communication device.

4. The vehicle of claim 3, wherein the one or more unique sounds are based on one of a status of the vehicle, a state of the vehicle, a behavior of the vehicle, and an operation of the vehicle.

5. The vehicle of claim 3, wherein the one or more unique sounds may indicate one or more of a notification prior to a movement of the vehicle, a normal operation of the vehicle when the vehicle is stationary, a normal operation of the vehicle when the vehicle is moving, a deceleration of the vehicle, the vehicle is stationary, the vehicle is turning, the vehicle is stopped at unload zone is the environment, an emergency stop supported by the vehicle is engaged, a soft stop of the vehicle is occurring, the vehicle is unable to determine a location of the vehicle relative to a predetermined map of the environment, the vehicle is disconnected from a communication network, the vehicle is blocked from proceeding on a planned route in the environment, an operator override is active, the vehicle is at a charging zone in the environment ready to charge a powertrain of the vehicle, the vehicle is charging the powertrain of the vehicle, the vehicle is approaching an intersection or an obstruction, the vehicle is entering a narrow corridor, a movement of the vehicle is locked, the vehicle is in remote mode for mapping the environment, and an operator changes a vehicle mode from a manual mode to an autonomous mode.

6. The vehicle of claim 1, wherein the at least one communication device includes at least one visual communication device and the vehicle further comprises a controller operatively coupled to the at least one visual communication device to produce one or more unique visual cues with the at least one visual communication device.

7. The vehicle of claim 6, wherein the one or more unique visual cues are based on at least one of a status of the vehicle, a state of the vehicle, a behavior of the vehicle, and an operation of the vehicle.

8. The vehicle of claim 6, wherein the at least one visual communication device includes a display capable of communicating one or more messages, the one or more messages including one or more of human-readable messages and machine-readable messages.

9. The vehicle of claim 8, wherein the one or more messages relate to at least one of a required operator interaction with the vehicle, an operation of the vehicle, a notification prior to movement of the vehicle, a normal operation of the vehicle when the vehicle is one of stationary and moving, a deceleration of the vehicle, the vehicle is stationary, the vehicle is turning, the vehicle is stopped at an unload zone in an environment, the vehicle is engaged in an emergency stop, the vehicle is engaged in a soft stop, the vehicle is unable to determine a location of the vehicle relative to a predetermined map of the environment, the vehicle is disconnected from a communications network, the vehicle is blocked from proceeding on a planned route in the environment, an operator override is active, the vehicle is at a charging zone in the environment ready to charge a powertrain of the vehicle, the vehicle is charging the powertrain of the vehicle, the vehicle has a low battery charge, the vehicle is approaching an intersection or an obstruction in the environment, the vehicle is entering a narrow corridor in the environment, the vehicle is locked, the vehicle is stationary and waiting for a job, the vehicle is in a remote mode for mapping the environment, and an operator changes a vehicle mode from a manual mode to an autonomous mode.

10. The vehicle of claim 1, further comprising:
a controller including a processor and a memory, the controller being operatively coupled to the at least one communication device; and
at least one sensor supported by the plurality of ground engaging members and operatively coupled to the controller.

11. The vehicle of claim 10, wherein the controller is configured to operate the vehicle in an autonomous mode in a constrained environment.

12. The vehicle of claim 11, wherein operation in the constrained environment includes one or more of a predetermined path of travel for the vehicle, monitoring stationary obstacles, monitoring moving obstacles, control of longitudinal vehicle stability during speed changes, control of lateral vehicle stability, a trajectory control of the vehicle, and monitoring a grade of the vehicle.

13. The vehicle of claim 11, wherein the vehicle is attached to a number of carts to be towed and wherein operation in the constrained environment includes a vehicle control based on the number of carts attached to the vehicle to be towed.

14. The vehicle of claim 13, wherein the controller prevents autonomous operation of the vehicle if the number of carts exceeds a predetermined number of carts based on at least one characteristic of the constrained environment.

15. The vehicle of claim 14, wherein the at least one characteristic of the constrained environment includes one of a width of a corridor in the environment, a number of turns the vehicle will have to traverse in the environment, a severity of angled turns the vehicle will have to traverse in the environment.

16. The vehicle of claim 10, wherein the at least one sensor includes one or more radar sensors, optical sensors, light detection and ranging (LiDAR) sensors, ultrasonic sensors, cameras, accelerometers, and inclinometers.

17. The vehicle of claim 10, wherein the controller determines an anticipated path of a moving object in the environment and whether the anticipated path intersects a planned trajectory of the vehicle.

18. The vehicle of claim 1, further comprising at least one emergency stop user input positioned at least at one of forward of the steering input and on the at least one upstanding frame member.

19. A method of controlling operation of a vehicle through a computer system, the method comprising:
monitoring with the computer system one or more sensors which monitor one or more vehicle characteristics;
determining with the computer system based at least on the one or more monitored vehicle characteristics if the vehicle is in an alert condition; and
providing with the computer system an alert regarding the alert condition if the vehicle is determined to be in the alert condition, wherein the one or more monitored vehicle characteristics include at least one of: a pending movement of the vehicle, a movement of the vehicle, a deceleration of the vehicle, the vehicle being stationary, the vehicle turning, the vehicle being positioned in an unload zone in the environment, a vehicle emergency stop, a vehicle soft stop, an inability of the vehicle to determine its location in the environment, the vehicle being disconnected from a network, the vehicle being blocked from proceeding on a planned route, an operator override of the vehicle is active, the vehicle is positioned at a charging zone in the environment, the vehicle is approaching an intersection in the environment, the vehicle is entering a particular location in the environment, the vehicle is locked and is awaiting an operator input, the vehicle is waiting for an assignment, the vehicle is in a remote mode for mapping, and an operator changes the operation mode of the vehicle.

20. The method of claim 19, wherein the alert is at least one of an audio alert, a visual alert, a haptic alert.
